(19) United States
(12) Patent Application Publication
(10) Pub. No.: US 2002/0122711 A1
(43) Pub. Date: Sep. 5, 2002

(54) Wheel nut retainer

(76) Inventor: Dena Porter, Etobicoke (CA)

Correspondence Address: Elias C. Borges, Kozlowski & Company, 5468 Dundas Street West, Suite 401, Toronto, ON, M9B 6E3, CA

(21) Appl. No.: 09/796,548

(22) Filed: Mar. 2, 2001

(51) Int. Cl. F16B 39/00

(52) U.S. Cl. 411/170

(57) ABSTRACT

A retainer for securing a truck wheel nut to a rim clamp of a wheel and thereby preventing the wheel nut from turning relative to the rim clamp is disclosed. The retainer comprises a substantially flat annular member made of a resilient metal, the annular member having an inner rim defining an opening and a planar outer rim circumferentially surrounding the inner rim. The outer rim has opposite first and second sides and the opening is dimensioned and configured to receive and secure the wheel nut. The retainer also has a first arm extending substantially perpendicularly from the first side of the outer rim at a first portion of the outer rim, and a second arm extending substantially perpendicularly from the first side of the outer rim at a second portion of the outer rim, the second portion of the outer rim being positioned at an obtuse angel relative to the first portion of the outer rim. The first and second arms each have a distal end opposite the outer rim and a barb positioned between the distal end and the outer rim, said first and second arms each having a length selected to position the barbs adjacent a lower edge of the rim clamp when the retainer is secured to the wheel nut, the barbs being oriented towards the opening and configured to grasp said lower edge when the retainer is secured to the wheel nut.

### FIELD OF THE INVENTION

The invention relates generally to wheel nut retainers for preventing the wheel nuts from accidentally loosening from the rim clamp by securing the wheel nut to the rim clamp.

### BACKGROUND OF THE INVENTION

Wheels are secured on commercial vehicles by a combination of rim clamps and wheel nuts. Even though the wheel nuts on commercial vehicle wheels are screwed onto their threaded rim clamps with a great amount of torque, they may loosen during driving. The slightest loosening of a wheel nut may cause vibration in a wheel, which may eventually lead to the wheel falling off the vehicle causing injuries and even death.

To improve safety, a number of nut retainers have been invented and are currently used on commercial vehicle wheels. These nut retainers comprise retainer rings or washers or, alternatively, clips attaching to retainer rings or washers. These nut retainers are effective, but they cannot be used on all wheels because some of the commercial vehicle wheels do not contain washers due to safety regulations. An example is tractor trailer wheels ( such as Dayton wheels). As a result, a number of deaths are reported every year due to wheels coming off of tractor trailers during driving.

### SUMMARY OF THE INVENTION

In accordance with the present invention, a retainer for securing a truck wheel nut to a rim clamp of a wheel and thereby preventing the wheel nut from turning relative to the rim clamp is provided. The retainer comprises a substantially flat annular member made of a resilient metal, the annular member having an inner rim defining an opening and a planar outer rim circumferentially surrounding the inner rim. The outer rim has opposite first and second sides and the opening is dimensioned and configured to receive and secure the wheel nut. The retainer also has a first arm extending substantially perpendicularly from the first side of the outer rim at a first portion of the outer rim, and a second arm extending substantially perpendicularly from the first side of the outer rim at a second portion of the outer rim, the second portion of the outer rim being positioned at an obtuse angle relative to the first portion of the outer rim. The first and second arms each have a distal end opposite the outer rim and a barb positioned between the distal end and the outer rim, said first and second arms each having a length selected to position the barbs adjacent a lower edge of the rim clamp when the retainer is secured to the wheel nut, the barbs being oriented towards the opening and configured to grasp said lower edge when the retainer is secured to the wheel nut.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention, in which.

### DESCRIPTION OF THE DRAWINGS

FIG. 1. is a top view of the present invention.

FIG. 2. is a bottom view of the present invention.

FIG. 3. is a cross-sectional view of the present invention taken through line A-A of FIG. 1.

FIG. 4. is a side view of the present invention, partly in cross-section, showing the retainer about to be applied to a wheel nut and rim clamp.

FIG. 5. is a side view of the present invention, partly in cross-section, showing the retainer secured to the wheel nut and rim clamp.

FIG. 6. is a top view of the present invention showing the retainer secured to the wheel nut and rim clamp.

FIG. 7. is a front view of the present invention.

In the drawings like characters of reference indicate corresponding parts in the different figures.

### DETAILED DESCRIPTION OF THE INVENTION

Referring firstly to FIG. 6, the present invention consists of a wheel retainer 10, which is designed to secure a wheel nut 12 to rim clamp 14. Retainer 10 comprises an annual member 16 having an inner rim 18 and outer rim 20 circumferentially surrounding inner rim 18. Inner rim 18 defines opening 26 which is configured to receive wheel nut 12. Outer rim 20 also has first arm 28 and second arm 30 which extends from first portion 32 of outer rim 20 and second portion 34 of outer rim 20, respectively. First portion 32 is at an obtuse angle relative to second portion 34.

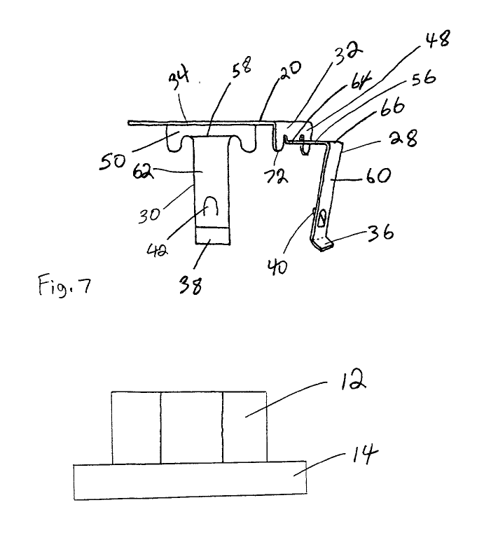

Referring now to FIG. 5, first arm 28 has barb 40 which is configured to grab lower edge 44 of rim clamp 14 when retainer 10 is secured to wheel nut 12 and rim clamp 14. First portion 32 has lip 48 which extends perpendicularly downward. Lip 48 has edge 72 which is adapted to bear against rim clamp 14. Lip 48 is dimensioned to separate outer rim portion 20 from rim clamp 14 when retainer 10 is secured to both wheel nut 12 and rim clamp 14. Arm 28 has shoulder 56 and elongated portion 60. Shoulder 56 is continuous with lip 48. Elongated portion 60 extends downwardly from end 66 of shoulder 56. The length of shoulder 56 is selected to ensure that elongated portion 60 is positioned adjacent wall 70 of rim clamp 14 when retainer 10 is secured to rim clamp 14.

Referring now to FIG. 4, elongated portion 60 is positioned substantially perpendicularly downward relative to shoulders 56 and outer rim portion 20. Preferably, elongated portion 60 of arm 28 is positioned at a slightly acute angle relative to shoulders 56 and outer rim portion 20, the slightly acute angle being selected to bias elongated portion 60 towards wall 70 of rim clamp 14 when retainer 10 is secured to the rim clamp, thereby ensuring that barb 40 remains in grasping engagement with lower edge 44 of rim clamp 14.

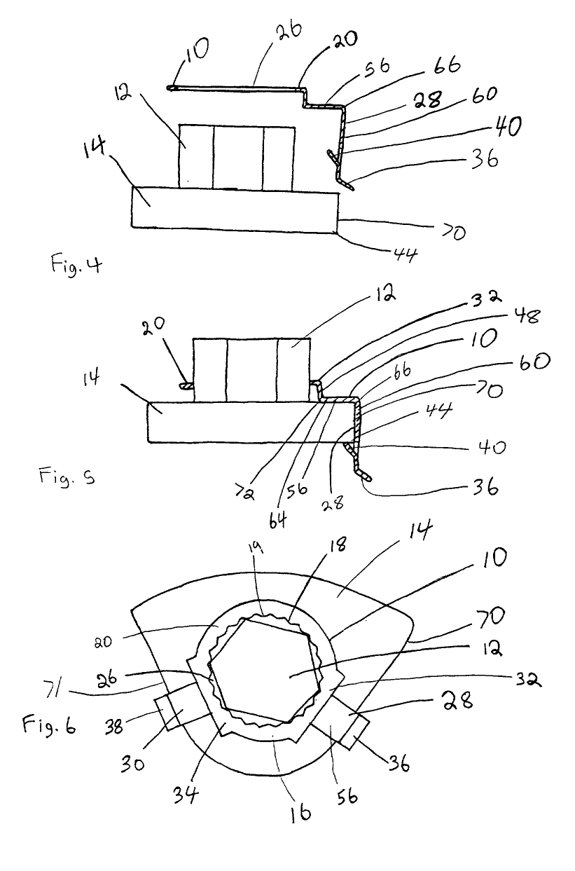

Referring now to FIG. 3, elongated portion 60 of arm 28 is at a slightly acute angle 46 from perpendicular line 11. Perpendicular line 11 is a hypothetical line drawn perpendicularly from shoulder 56. Preferably angle 46 is 5 degrees, which is sufficient to bias elongated portion 60 towards clamp 14 with sufficient force to ensure that barb 40 remains clamped to lower edge 44. It has been discovered that if slightly acute angle 46 is approximately 5 degrees, retainer 10 will remain firmly secured to rim clamp 14. Barb 40 is preferably a punched out portion of elongated portion 60 of arm 28. Barb 40 is positioned at an acute angle 74 relative to elongated portion 60. Preferably acute angle 74 is approximately 45 degrees. It has been discovered that if acute angle 74 is approximately 45 degrees, barb 40 remains securely attached to a lower edge 44 of rim 14 when retainer 10 is secured to wheel nut 12 and wheel rim clamp 14. Distal end 36 of arm 28 is adapted to be grasped such that it can be forced away from opening 26. Preferably distal end 36 is at a distance from barb 40 so that a mechanical advantage exists when distal end 36 is moved away from opening 26. This mechanical advantage is selected to permit a user to disengage barb 40 from edge 44 of clamp rim 14.

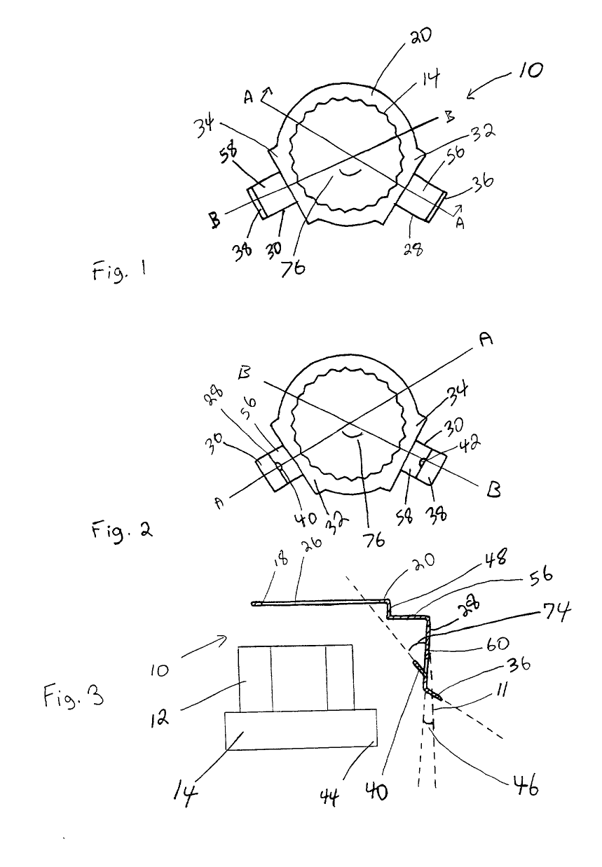

Referring now to FIGS. 1 and 2, retainer 10 has two arms 28 and 30 extending from first portion 32 and second portion 34 of outer rim 20, respectively. First portion 32 is at an obtuse angle 76 from second portion 34. Obtuse angle 76 is defined by lines AA drawn through first portion 32 and line BB drawn through second portion 34. Preferably obtuse angle 76 is 120 degrees. Referring now to FIG. 6, since first portion 32 and second portion 34 of outer rim 20 are at an obtuse angle to each other, arms 28 and 30, respectively and, are positioned to engage walls 70 and 71 of wheel rim clamp 14.

Referring now to FIG. 7, arms 30 and 28 are identical. In particular, arm 30 has a elongated portion 62, shoulder portion 58, barb 42 and distal end 38. Also, arm 30 extends from lip portion 50, which descends perpendicularly from second portion 34 of outer rim 20.

Referring now to FIGS. 4, 5 and 6, the application of retainer 10 to wheel nut 12 and rim clamp 14 will now be discussed. To secure wheel nut 12 to rim clamp 14 such that the wheel nut cannot rotate relative to the rim clamp, retainer 10 is used to rigidly secure the wheel nut to the rim clamp. Retainer 10 is positioned above wheel nut 12 such that the wheel nut is aligned with opening 26. Retainer 10 is then forced downward so that the wheel nut 12 is inserted into the retainer and outer rim portion 20 surrounds the wheel nut. As retainer 10 is forced onto wheel nut 12, elongated portion 60 of arm 28, being at a slightly acute angle relative to outer rim portion 20 urges the elongated portion towards rim clamp 14, which in turn biases barb 40 towards lower edge 44 of rim clamp 14. When fully attached as shown in FIG. 5, retainer 10 is locked onto rim clamp 14 and cannot be removed accidentally. As seen in FIG. 6, inner rim 18 has a plurality of ridges 19 which prevent wheel nut 12 from turning. Lip 48 holds outer rim portion 20 away from rim clamp 14, therefore preventing the outer rim portion from slipping between wheel nut 12 and rim clamp 14. By keeping outer rim portion 20 clear of rim clamp 14, retainer 10 maintains better contact with wheel nut 12 preventing the wheel nut from loosening.

When it is time to service the wheel, wheel nut 12 will have to be unscrewed from rim clamp 14. Before wheel nut 12 can be removed, retainer clip 10 will have to be removed. A user may remove retainer clip 10 by grasping distal ends 36 and 38 and forcing them away from rim clamp 14. Forcing distal ends 36 and 38 away from rim clamp 14 causes arms 28 and 32 to bend slightly. Since barbs 42 and 40 are some distance from distal ends 38 and 36, respectively, there is a mechanical advantage making it easier to disengage the barbs from rim clamp 14. With the barbs disengaged from the lower edge of the rim clamp, retainer 10 may be removed.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A retainer for securing a truck wheel nut to a rim clamp of a wheel, the retainer comprising;
(a) a substantially flat annular member made of a resilient metal, the annular member having an inner rim defining an opening and a planar outer rim circumferentially surrounding the inner rim, said outer rim having opposite first and second sides, said opening dimensioned and configured to receive and secure the wheel nut,
(b) a first arm extending substantially perpendicularly from the first side of the outer rim at a first portion of the outer rim,
(c) a second arm extending substantially perpendicularly from the first side of the outer rim at a second portion of the outer rim, the second portion of the outer rim being positioned at an obtuse angle relative to the first portion of the outer rim,
(d) the first and second arms each having a distal end opposite the outer rim and a barb positioned between the distal end and the outer rim, said first and second arms each having a length selected to position the barbs adjacent a lower edge of the wheel clamp when the retainer is secured to the wheel nut, the barbs being oriented towards the opening and configured to grasp said lower edge when the retainer is secured to the wheel nut.

2. A nut retainer as defined in claim 1 wherein the first and second arms are at a slightly acute angle relative to the first and second portions of the outer rim, respectively, the slightly acute angle selected to urge the distal ends of the arms towards the lower edge of the wheel clamp with a force selected to keep the barbs in grasping contact with the lower edge when the retainer is secured to the wheel nut.

3. A nut retainer as defined in claim 2 wherein the outer rim includes a lip extending from the first side of the outer rim, the lip having a lower edge adapted to bear against the wheel clamp, the lip dimensioned to separate the outer rim from the wheel clamp when the retainer is secured to the wheel nut and the barbs engage the lower edge of the wheel clamp.

4. A nut retainer as defined in claim 3 wherein the lip is positioned adjacent the first and second portions of the outer rim.

5. A nut retainer as defined in claim 2 wherein the first and second portions of the outer rim each includes a lip portion extending substantially perpendicularly from the first side of the outer rim, the lip having a lip edge adapted to bear against the wheel clamp, the lip dimensioned to separate the outer rim from the wheel clamp when the retainer is secured to the wheel nut and the barbs engage the lower edge of the wheel clamp, each arm being attached to the lip at a point on the lip adjacent the lip edge.

6. A nut retainer as defined in claim 5 wherein each arm has a substantially planar shoulder portion and an elongated portion extending from the shoulder portion, each shoulder portion being a continuation of the lip, each shoulder portion being parallel to the outer rim and having a first end attached to the lip and an opposite second end from which the elongated portion extends, each barb positioned between the distal end and the shoulder, each shoulder having a length selected to position the elongated portion adjacent a side of the wheel clamp when the retainer is secured to the wheel nut.

7. A nut retainer as defined in claim 6 wherein each shoulder extends perpendicularly from its respective lip and wherein each elongated portion extends at a slightly acute angle from its respective shoulder.

8. A nut retainer as defined in claim 1 wherein the obtuse angle is approximately 120°.

9. A nut retainer as defined in claim 2 wherein the slightly acute angle is approximately 5° from perpendicular.

10. A nut retainer as defined in claim 2 wherein the distal end is adapted to be grasped and wherein the distal end is positioned a distance from the barb, the distance selected to provide a mechanical advantage for disengaging the barb from the lower edge of the wheel clamp.
